(19) United States
(12) Patent Application Publication
(10) Pub. No.: US 2026/0073253 A1
(43) Pub. Date: Mar. 12, 2026

(54) Hybrid Content Item Chunking For Retrieval Augmented Generation

(71) Applicant: Oracle International Corporation, Redwood Shores, CA (US)

(72) Inventors: Xin Zhang, Seattle, WA (US); Zheng Wang, Sammamish, WA (US); Mengqing Guo, Redmond, WA (US); Yazhe Hu, Bellevue, WA (US); Zhonghai Deng, Redmond, WA (US); Yimo Liu, Seattle, WA (US); Yuying Wang, Lexington, KY (US); Genyi Huang, Boston, MA (US); Rongguang Wang, Seattle, WA (US); Tao Sheng, Bellevue, WA (US)

(73) Assignee: Oracle International Corporation, Redwood Shores, CA (US)

(21) Appl. No.: 18/916,272

(22) Filed: Oct. 15, 2024

Related U.S. Application Data
(60) Provisional application No. 63/691,943, filed on Sep. 6, 2024.

(51) Int. Cl. G06N 5/04; G06F 40/211; G06F 40/30

(52) U.S. Cl. CPC G06N 5/04; G06F 40/211; G06F 40/30

(57) ABSTRACT

Hybrid content item chunking techniques for retrieval augmented generation (RAG) systems are disclosed. The techniques employ a dual approach, combining size-based and semantic chunking with layout-based chunking. The techniques analyze content for layout indicators, creating two sets of chunks that are then merged into a hybrid set. This hybrid set is loaded into a database for subsequent searches. The techniques offer several technical advantages, including improved handling of diverse document types, potential for parallel processing, and enhanced capture of both semantic meaning and structural layout. By maintaining size constraints and adapting to various formats, the techniques provide a more comprehensive representation of document content. The techniques overcome limitations of single-method approaches, potentially leading to more accurate information retrieval, improved context preservation, and enhanced RAG system performance across varied document types.

### PRIORITY CLAIM

This application claims the benefit of priority of U.S. provisional patent application No. 63/691,943 , filed Sep. 6, 2024, the entire contents of which are hereby incorporated by reference as if fully set forth herein.

### TECHNICAL FIELD

This application relates generally to generative artificial intelligence systems. In particular, this application relates to chunking strategies for retrieval augmented generation in generative artificial intelligence systems.

### BACKGROUND

Generative artificial intelligence (AI) agents are conversational systems powered by large language models (LLMs) trained on vast amounts of text data. These models, sometimes based on transformer architectures, use self-attention mechanisms and deep neural networks to generate human-like responses to user inputs. They operate by predicting the most likely sequence of tokens given a prompt, leveraging patterns learned from their training data. While powerful, these systems often struggle with up-to-date information, factual accuracy, and consistency across interactions due to their reliance on static, pre-trained knowledge.

Retrieval Augmented Generation (RAG) is an advanced natural language processing (NLP) technique that combines information retrieval with text generation to produce more accurate and contextually relevant outputs. This approach enhances LLMs by incorporating external knowledge sources during the generation process.

RAG and generative AI agents operate in combination to overcome limitations of traditional LLMs. When a user query is received, the RAG system first retrieves relevant information from its knowledge base. This retrieved data is then used to augment the context provided to the generative AI. The AI agent processes this enriched input to generate a response. This combined approach allows for more current and accurate information in outputs and enables the system to provide citations or references for its responses. The integration of RAG with generative AI results in more reliable and informative interactions.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

One or more embodiments of the present disclosure are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example multi-tenant provider network environment in which techniques for hybrid content item chunking for retrieval augmented generation are implemented in accordance with an embodiment of the present disclosure;

FIG. 2 is a flowchart of a method for hybrid content item chunking for retrieval augmented generation in accordance with an embodiment of the present disclosure;

FIG. 3 illustrates an example chunking process in accordance with an embodiment of the present disclosure;

FIG. 4 depicts an approach for evaluating a hybrid chunking process within a retrieval augmented generation framework in accordance with an embodiment of the present disclosure;

FIG. 5 illustrates an example of hybrid content item chunking for retrieval augmented generation in accordance with an embodiment of the present disclosure; and

FIG. 6 illustrates an example computer system for use in an implementation of hybrid content item chunking for retrieval augmented generation in accordance with an embodiment of the present disclosure.

### DETAILED DESCRIPTION

In the following detailed description, for the purposes of explanation, numerous specific details are set forth to aid understanding of one or more embodiments of the present disclosure. In some instances, an embodiment of the present disclosure may be practiced without one or more of these specific details. In some cases, a described feature of one embodiment of the present disclosure is also a feature of one or more other embodiments of the present disclosure even though the feature is not expressly described with respect to the one or more other embodiments. In some embodiments, well-known structures and devices are shown in the figures in block diagram form to avoid unnecessarily obscuring the embodiment.
1. GENERAL OVERVIEW
2. SYSTEM FOR HYBRID CONTENT ITEM CHUNKING FOR RETRIEVAL AUGMENTED GENERATION
3. METHOD FOR HYBRID CONTENT ITEM CHUNKING FOR RETRIEVAL AUGMENTED GENERATION
4. EXAMPLE CHUNKING PROCESS
5. CHUNKING EVALUATION
6. EXAMPLE EMBODIMENT
7. COMPUTER NETWORKS AND CLOUD NETWORKS
8. HARDWARE OVERVIEW
9. EXTENSIONS; ALTERNATIVES

### 1. General Overview

One or more embodiments of a hybrid content item chunking system and method for content item chunking in retrieval augmented generation (RAG) systems uses a dual approach of size-based and semantic chunking on a portion of the content item. This chunking process yields a first set of content chunks. Concurrently, one or more embodiments analyze the content for layout indicators, identifying layout chunking markers. These markers guide a second chunking process, combining size-based and layout-based approaches to produce a second set of content chunks. One or more embodiments then merge the two sets, creating a hybrid set of content chunks that incorporates elements from both initial sets. This hybrid set is subsequently loaded into a database system. One or more embodiments use the database system to conduct searches within the hybrid chunk set. One or more embodiments improve content segmentation for more effective retrieval and generation processes. By employing multiple chunking strategies, one or more embodiments enhance the ability to capture both semantic meaning and structural layout, thereby improving the overall performance of RAG systems and enabling more precise and contextually relevant information retrieval and generation.

One or more embodiments offer several significant technical advantages. One or more embodiments combine semantic, layout, and size-based chunking strategies to capture various aspects of document structure. Such multifaceted chunking overcomes limitations of single-method approaches. Integrating size-based chunking ensures that a chunk meets or does not exceed an optimal size for embedding generation or RAG processes. This size control enhances efficiency and compatibility with downstream artificial intelligence (AI) models. One or more embodiments provide flexibility that allows for improved handling of heterogeneous document types, adapting to various structures and formats. This adaptability is useful in real-world applications, where document formats can vary widely. One or more embodiments allow for parallel processing of chunking. Parallel processing can significantly reduce computation time, especially for large documents or high-volume processing scenarios. By capturing both semantic meaning and structural layout while maintaining size constraints, one or more embodiments provide a more comprehensive and nuanced representation of document content. Such chunking can lead to more accurate information retrieval, improved context preservation, and enhanced performance in RAG systems across various document types.

One or more embodiments can be generalized for use in non-RAG systems, expanding their applicability across various information processing domains. In NLP tasks, one or more embodiments can enhance text summarization by creating semantically coherent and structurally aligned chunks. These chunks serve as useful input for summarization algorithms. For information retrieval systems, one or more embodiments improve indexing granularity, which allows for more precise document retrieval based on both content and structure. In machine translation, one or more embodiments are applied to segment source texts effectively. Effective segmentation preserves context and structural integrity during the translation process. One or more embodiments have applications in document classification systems. By providing a multifaceted representation of documents, one or more embodiments allow for more nuanced classification based on both content and structure. Additionally, in text analytics platforms, one or more embodiments facilitate more accurate sentiment analysis and topic modeling by considering both semantic and structural aspects of the text.

The generalization of hybrid chunking techniques extends to content management systems and digital libraries. In these contexts, the hybrid chunking techniques can improve content organization, search functionality, or metadata extraction. The ability of one or more embodiments to handle various document types is useful for processing heterogeneous collections. For example, in academic research databases, one or more embodiments can enhance the indexing of research papers. Enhanced indexing allows for more targeted searches across different sections of papers. In legal document analysis, one or more embodiments can improve the identification and extraction of key clauses and arguments. Thus, one or more embodiments facilitate more efficient legal research and case analysis. The adaptability of one or more embodiments also makes them suitable for processing multimedia content descriptions. By chunking textual metadata associated with audio or video content, one or more embodiments can enhance searchability and discoverability in multimedia databases. These varied applications demonstrate the versatility and impact of one or more embodiments beyond RAG systems.

One or more embodiments described in this Specification and/or recited in the claims may not be included in the General Overview section.

### 2. Multi-Tenant Provider Network Environment

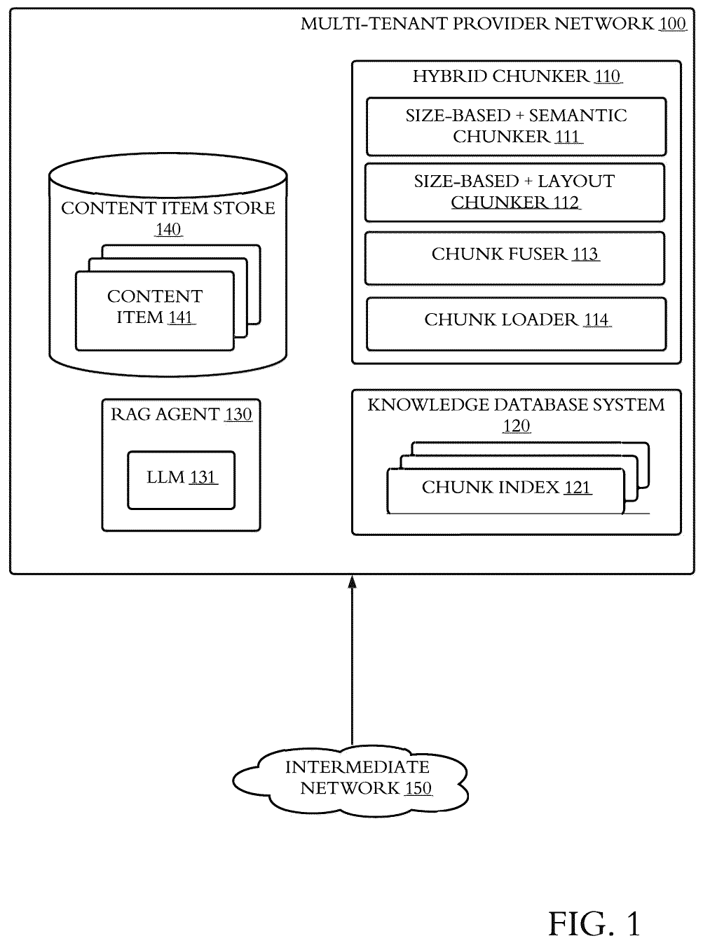

FIG. 1 illustrates a multi-tenant provider network architecture designed for advanced content processing and retrieval augmented generation according to an embodiment of the present disclosure. The multi-tenant provider network 100 encompasses four main components: a hybrid content item chunker 110, a knowledge database system 120, a retrieval augmented generation (RAG) agent referred to in FIG. 1 as RAG agent 130, and a content item store 140. The hybrid content item chunker 110 encompasses at least four subcomponents: a size-based plus semantic chunker 111, a size-based plus layout chunker 112, a chunk fuser 113, and a chunk loader 114. These subcomponents work in tandem to process content items using various chunking strategies. The knowledge database system 120 houses a set of one or more chunk indexes 121 for efficient information retrieval. The RAG agent 130 incorporates a large language model (LLM) referred to in FIG. 1 as LLM 131 for advanced NLP capabilities. The content item store 140 serves as a repository for a set of content items 141, providing the raw material for processing by the hybrid content item chunker 110. The multi-tenant provider network 100 is connected to external devices and systems through an intermediate network 150 that facilitates data exchange and system integration. The architecture's design allows for efficient content processing, chunking, indexing, and retrieval, supporting advanced RAG operations across multiple tenants.

As used herein, unless the context clearly indicates otherwise, a “chunk” refers to a discrete segment or unit of content extracted from a larger body of information such as a content item. Chunks represent meaningful subdivisions of data that are designed to facilitate efficient processing, storage, and retrieval operations. The size and composition of chunks can vary based on the specific application and chunking strategy employed. Chunks may be defined by semantic coherence, maintaining logical relationships within the segmented content. Alternatively, chunks can be determined by structural elements, such as paragraphs, sections, or layout markers. In some cases, chunks are created based on fixed size limits, ensuring uniform data units for processing. The concept of chunking applies across various data types, including text documents, multimedia content, and structured datasets. Effective chunking strategies aim to preserve context and relevance within a segment while optimizing computational efficiency and storage requirements. Chunks generated according to techniques disclosed herein may be used in numerous information processing tasks, including indexing, search operations, NLP, and machine learning applications.

As used herein, unless the context clearly indicates otherwise, a “content item” refers to a discrete unit of digital information or data that conveys meaning, knowledge, or creative expression. Content items encompass a wide range of digital assets, including but not limited to textual documents, images, audio files, video recordings, and structured data sets. These items can vary significantly in size, complexity, and format, ranging from simple text files to complex multimedia presentations. Content items may possess metadata attributes that describe their characteristics, such as creation date, author, file type, and access permissions. In information management systems, content items serve as the fundamental objects for storage, retrieval, and manipulation. Content items may be static, representing fixed information, or dynamic, capable of updating based on user interactions or external data sources. The content items may be accessed or managed by content management systems, digital asset management, and information retrieval applications. Content items can be standalone entities or components of larger, composite structures, such as web pages or digital publications.

In an embodiment, the multi-tenant provider network 100 is an architectural framework designed for content processing and retrieval augmented generation services. This network infrastructure supports multiple tenants, allowing shared resources while maintaining data isolation. The multi-tenant provider network 100 integrates four primary components: a hybrid content item chunker 110, a knowledge database system 120, a RAG agent 130, and a content item store 140. These components work in combination to process, store, and retrieve information efficiently. The hybrid content item chunker 110 employs various chunking strategies to optimize content segmentation. The knowledge database system 120 serves as a structured repository for processed information. The RAG agent 130, powered by a LLM 131, enables sophisticated NLP and generation. The content item store 140 acts as a data source for the hybrid content item chunker 110.

In an embodiment, a multi-tenant provider network 100 is an architectural framework designed to serve multiple clients, or tenants, simultaneously within a shared computing environment. This type of network uses the principles of multi-tenancy, where a single instance of software and its supporting infrastructure serves multiple customers. A tenant's data remains isolated and invisible to other tenants, ensuring security and privacy. The multi-tenant provider network 100 may offer a range of services, such as software-as-a-service (SaaS), platform-as-a-service (PaaS), or infrastructure-as-a-service (IaaS). These services are delivered through a shared infrastructure, optimizing resource utilization and reducing operational costs. The network architecture incorporates mechanisms for data partitioning, access control, and performance isolation. Scalability is a feature, allowing the multi-tenant provider network 100 to accommodate varying workloads across tenants efficiently. Multi-tenant provider network 100 may implement advanced load balancing, automated provisioning, and dynamic resource allocation to ensure optimal performance for users. This approach enables businesses to benefit from economies of scale, reduce maintenance overhead, and rapidly deploy services, while maintaining the flexibility to customize applications and data models for individual tenant requirements.

In an embodiment, the hybrid content item chunker 110 is a content processing subsystem within the multi-tenant provider network 100. This component employs multiple chunking strategies to optimize content segmentation for retrieval and generation tasks. The hybrid content item chunker 110 encompasses four subcomponents: a size-based plus semantic chunker 111, a size-based plus layout chunker 112, a chunk fuser 113, and a chunk loader 114. The size-based plus semantic chunker 111 combines size constraints with semantic analysis to create meaningful content segments. Concurrently, the size-based plus layout chunker 112 integrates size limitations with layout-based segmentation, capturing structural elements of the content. The chunk fuser 113 merges the outputs from both chunking methods, creating a comprehensive set of hybrid chunks that capture both semantic and structural aspects of the content. Finally, the chunk loader 114 transfers the processed chunks into the knowledge database system 120. This multi-faceted approach allows the hybrid content item chunker 110 to handle various content types efficiently, balancing semantic coherence, structural integrity, and size optimization. By employing these varied chunking strategies, the hybrid content item chunker 110 enhances the overall performance of the RAG agent 130, providing a more nuanced and comprehensive content representation for downstream processing.

In an embodiment, the hybrid content item chunker 110 is a text processing system that employs multiple chunking strategies to segment content effectively. The hybrid content item chunker 110 combines various approaches to content division, including semantic, layout-based, and size-constrained methods. The semantic component analyzes the meaning and context of the text to create logically coherent segments. Concurrently, the layout-based approach considers structural elements, such as headings, paragraphs, or formatting, to inform the chunking process. A size constraint mechanism ensures that chunks remain within predefined limits, optimizing for downstream processes, like embedding generation or retrieval. The hybrid nature of this hybrid content item chunker 110 allows for a more comprehensive and nuanced segmentation of content, adapting to various document types and structures. By fusing the results of these different chunking methods, the hybrid content item chunker 110 produces a set of hybrid chunks that capture both the semantic essence and the structural layout of the original content. This multi-faceted approach enhances the chunker 110's versatility, making it suitable for various content processing tasks in information retrieval, NLP, and machine learning applications. The hybrid content item chunker 110 thus provides a foundation for advanced text analysis and generation systems, improving the overall quality and relevance of processed content.

In an embodiment, the size-based plus semantic chunker 111 is a component of the hybrid content item chunker 110. This subsystem employs a dual-strategy approach to content segmentation, combining size-based constraints with semantic analysis. The size-based aspect ensures that a chunk meets or does not exceed a predefined length, which is useful for maintaining compatibility with downstream processes, such as embedding generation or retrieval augmented generation. Concurrently, the semantic aspect analyzes the content's meaning, context, and logical flow to create coherent and meaningful segments. This semantic analysis may involve techniques, such as NLP, topic modeling, or sentence boundary detection. The size-based plus semantic chunker 111 utilizes algorithms to balance these two requirements, such as employing sliding window techniques or dynamic programming to optimize chunk boundaries. By integrating size limitations with semantic understanding, the size-based plus semantic chunker 111 produces content segments that are both manageable in size and semantically cohesive. This approach enhances the overall quality of content representation, improving the performance of subsequent retrieval and generation tasks within the multi-tenant provider network.

In an embodiment, the size-based plus layout chunker 112 is a component within the hybrid content item chunker 110. This size-based plus layout chunker 112 employs a dual-strategy approach to document segmentation. The size-based plus layout chunker 112 first analyzes the content item for layout indicators, identifying structural elements, such as headings, paragraphs, lists, and tables. These layout markers serve as potential chunk boundaries. Concurrently, the size-based plus layout chunker 112 enforces a size-based constraint on a chunk. The size-based limit ensures that a chunk meets or does not exceed a predefined token or character count, facilitating efficient processing in downstream tasks. The size-based plus layout chunker 112 dynamically adjusts chunk boundaries to respect both layout integrity and size limitations. When encountering a layout marker, the size-based plus layout chunker 112 initiates a new chunk if the current chunk has not reached a size-based constraint. If a layout section exceeds the size-based constraint, the size-based plus layout chunker 112 subdivides the section while attempting to preserve semantic coherence. This approach results in chunks that balance structural fidelity with practical size constraints, optimizing the content for retrieval and embedding generation in RAG systems.

In an embodiment, the chunk fuser 113 is responsible for integrating the outputs from the size-based plus semantic chunker 111 and the size-based plus layout chunker 112. The chunk fuser 113 merges and reconciles the chunk sets produced by the preceding size-based plus semantic chunker 111 and the size-based plus layout chunker 112. The chunk fuser 113 analyzes the boundaries, content, and metadata of a chunk from both sets. Overlapping or redundant chunks are identified and consolidated. The chunk fuser 113 preserves unique chunks from a set, ensuring that both semantic and layout-based segmentations are represented in the final output. When conflicts arise between chunk boundaries, the fuser applies resolution strategies that prioritize maintaining context and coherence. These strategies may include chunk splitting, merging, or boundary adjustment. The chunk fuser 113 may also assign metadata tags to a resulting chunk, indicating the origin (semantic, layout, or hybrid) and any relevant attributes. This process culminates in a unified, de-duplicated set of chunks that uses the strengths of both chunking approaches. The fused chunk set offers a comprehensive representation of the document, optimized for flexible and effective retrieval in downstream RAG operations.

In an embodiment, the chunk loader 114 is designed to efficiently transfer the fused chunks into the knowledge database system 120. The chunk loader 114 handles the task of preparing and inserting the processed content segments for efficient retrieval. The chunk loader 114 begins by validating a chunk's format and metadata, ensuring consistency and completeness. Next, the chunk loader 114 applies any necessary transformations or encodings to optimize the chunks for database storage and indexing. These transformations may include normalizing text, extracting entities, or generating embeddings for vector search capabilities. The chunk loader 114 then interfaces with the knowledge database system 120's ingestion APIs, managing the bulk insertion of chunks while maintaining data integrity and consistency. During the loading process, the chunk loader 114 handles potential conflicts or duplicates, applying predefined resolution strategies. The chunk loader 114 also updates or creates the chunk indexes 121 within the knowledge database system 120, enabling fast and accurate retrieval. Performance optimization techniques, such as batch processing and parallel loading, are employed to handle large volumes of chunks efficiently. The chunk loader 114 maintains logs of the loading process, recording metrics and any exceptions encountered, which facilitates monitoring and troubleshooting of the ingestion pipeline.

In an embodiment, the knowledge database system 120 serves as a repository for processed content chunks, optimized for rapid retrieval and semantic search operations. The knowledge database system 120 employs advanced indexing structures, particularly the set of chunk indexes 121, which facilitate efficient querying across various dimensions of the stored content. These chunk indexes 121 may include inverted indexes for keyword searches, spatial indexes for layout-based queries, and dense vector indexes for semantic similarity comparisons. These dense vectors are sometimes referred to as “semantic embeddings” or just “embeddings. ” The knowledge database system 120 supports multi-modal storage and accommodates text, metadata, and potentially embedded representations of the chunks.

As used herein, unless the context clearly indicates otherwise, the terms “dense vector”, “semantic embedding”, and “embedding” refer to a mathematical representation that maps discrete or continuous data to a vector space of fixed dimensionality. This mapping may preserve semantic relationships and structural properties of the original data. Embeddings may capture meaningful features and similarities, enabling efficient comparison and analysis. The resulting vectors may have lower dimensionality than the input data, facilitating dimensionality reduction. These dense representations allow algorithms to process complex data types more effectively. Embedding techniques include word embeddings, graph embeddings, and image embeddings. Embeddings can be learned through various methods, such as neural networks or matrix factorization. The choice of embedding method may depend on the requirements of the specific data type and task at hand.

In an embodiment, to support the RAG agent 130, the knowledge database system 120 implements low latency read operations and scalable architecture to handle concurrent queries. When the RAG agent 130 initiates a retrieval request, the knowledge database system 120 accesses its indexing structures to quickly identify and rank relevant chunks. The knowledge database system 120 may employ hybrid search strategies, combining exact match, fuzzy search, and vector similarity to provide comprehensive results. These results are then returned to the RAG agent 130, possibly with associated relevance scores and metadata.

In an embodiment, the knowledge database system 120's design allows for dynamic updates, enabling the continuous integration of new or modified content without significant downtime. This feature ensures that the RAG agent 130 has access to current information. Additionally, the knowledge database system 120 may implement caching mechanisms and query optimization techniques to further enhance performance, particularly for frequently accessed chunks or common query patterns. By providing fast, accurate, and contextually relevant information retrieval, the knowledge database system 120 supports the generative capabilities of the LLM 131.

In an embodiment, the knowledge database system 120 supports the RAG agent 130 as a specialized data storage and retrieval system designed to enhance the performance of the LLM 131 in information-intensive tasks. This knowledge database system 120 serves as a repository for structured and unstructured data, preprocessed into manageable chunks or segments by hybrid content item chunker 110. The database architecture incorporates indexing mechanisms, such as inverted indexes, B-tree structures, or vector indexes, to facilitate rapid and accurate information retrieval. These chunk indexes 121 enable efficient searching across multiple dimensions, including textual content, metadata, and semantic representations.

In an embodiment, the knowledge database system 120 employs query processing algorithms to interpret and execute search requests from the RAG agent 130. These algorithms may leverage techniques, like semantic similarity matching, keyword-based retrieval, and relevance ranking, to identify the most pertinent information. Vector embeddings of text chunks may be used to capture semantic relationships, allowing for similarity comparisons. The knowledge database system 120 may be optimized for low latency read operations, useful for maintaining the responsiveness of the RAG agent 130 during real-time interactions.

In an embodiment, the chunk indexes 121 in the knowledge database system 120 are data structures designed to optimize the retrieval of content chunks. These chunk indexes 121 serve as navigational aids, significantly reducing the time required to locate relevant information within the vast repository of stored chunks. Multiple index types may coexist, tailored to support different query patterns and retrieval strategies. Inverted indexes map terms or tokens to the chunks containing them, enabling rapid keyword-based searches. B-tree or similar hierarchical structures facilitate range queries and ordered traversals of chunks based on specific attributes. Dense vector indexes enable efficient similarity searches in high-dimensional embedding spaces. These vector indexes are useful for semantic retrieval, allowing for the identification of conceptually related chunks even in the absence of exact keyword matches. Additional specialized indexes may be implemented to support faceted searches, geospatial queries, or time-based retrievals, depending on the nature of the stored content. The chunk indexes 121 may be updated as new chunks are added or existing ones are modified, ensuring that the retrieval system always operates on a current state of the knowledge base. By providing multiple, complementary access paths to the stored chunks, these chunk indexes 121 enable the RAG agent 130 to swiftly retrieve the most pertinent information, thereby enhancing the LLM 131's ability to generate contextually relevant and accurate responses.

In an embodiment, the RAG agent 130 combines retrieval capabilities with generative AI to produce contextually informed responses. The RAG agent 130 incorporates the LLM 131, which serves as a mechanism for natural language understanding and generation. When presented with a query or prompt, the RAG agent 130 first formulates a retrieval strategy to extract relevant information from the knowledge database system 120. This retrieval process may involve generating embeddings of the input query, constructing complex database queries, or employing multi-stage retrieval techniques to ensure comprehensive coverage of pertinent information.

In an embodiment, upon receiving results from the knowledge database, the RAG agent 130 processes and integrates this retrieved information with the original query. The RAG agent 130 may employ various techniques, such as relevance scoring, information fusion, or context prioritization, to prepare the retrieved data for consumption by the LLM 131. The LLM 131 then uses this augmented context to generate a response, effectively combining its pre-trained knowledge with the retrieved, up-to-date information. This approach allows the RAG agent 130 to produce outputs that are fluent, coherent, and grounded in the most current and relevant data available in the knowledge database.

In an embodiment, the RAG agent 130 implements mechanisms, such as query reformulation, iterative retrieval, or multi-turn dialogue management, to handle complex or ambiguous queries. By dynamically using external knowledge in conjunction with the generative capabilities of the LLM 131, the RAG agent 130 achieves a balance between the broad knowledge captured in the LLM 131 and the specific, current information stored in the knowledge database system 120.

In an embodiment, the LLM 131 encompasses a neural network architecture designed for advanced NLP tasks. The LLM 131 may employ a transformer-based architecture, utilizing self-attention mechanisms to process and generate text. The LLM 131 is pre-trained on vast corpora of text data, enabling the LLM 131 to capture complex linguistic patterns, semantic relationships, and world knowledge. Through this pre-training, the LLM 131 develops capabilities for tasks, such as text completion, question answering, and contextual understanding.

In an embodiment, within the RAG agent 130, the LLM 131 functions as both an encoder and a decoder. As an encoder, the LLM 131 processes input queries and retrieves context, transforming them into high-dimensional vector representations. In its decoder role, the LLM 131 generates coherent and contextually appropriate responses based on the encoded information. The LLM 131 uses attention mechanisms to focus on relevant parts of the input and retrieved context during generation. Fine-tuning techniques may be applied to adapt the LLM 131 to specific domains or tasks, enhancing its performance within the RAG agent 130. The LLM 131's output may be produced through autoregressive generation, where a token is predicted based on the preceding tokens and the provided context. Advanced decoding strategies, such as beam search or nucleus sampling, may be employed to improve the quality and variety of generated responses. By integrating the broad knowledge captured in its parameters with the specific information retrieved from the knowledge database, the LLM 131 enables the RAG agent 130 to produce informed, coherent, and contextually relevant outputs.

In an embodiment, LLM 131 is implemented using one of various architectures and techniques, with distinct characteristics and trade-offs. One possible implementation is based on the transformer architecture, utilizing multi-head, self-attention mechanisms. This approach, exemplified by models, like Generative Pre-trained Transformer (GPT), Bidirectional Encoder Representations from Transformers (BERT), and their derivatives, allows for parallel processing of input sequences and captures long-range dependencies effectively. Transformer-based LLMs can be further categorized into encoder-only (e.g., BERT), decoder-only (e.g., GPT), or encoder-decoder (e.g., T5) models, suited for different types of tasks. Alternative implementations include recurrent neural networks (RNNs) with long short-term memory (LSTM) or gated recurrent units (GRU), which process sequences sequentially. Convolutional neural networks (CNNs) are also possible for text processing, offering efficient local feature extraction. Mixture of experts (MoE) models are another possible implementation of LLM 131, where multiple specialized sub-networks are selectively activated based on input, allowing for larger model capacities with reduced computational demands. An implementation of LLM 131 may incorporate techniques, such as sparse attention mechanisms, which reduce computational complexity by focusing on relevant parts of the input.

In an embodiment, the content item store 140 serves as the primary repository for raw, unprocessed content within the multi-tenant provider network 100. This storage system is designed to efficiently manage and organize a varied array of content items 141, which may include documents, articles, web pages, or other textual and potentially multimedia data sources. The content item store 140 employs data structures and indexing mechanisms to facilitate rapid storage and retrieval operations. These mechanisms may include B-tree indexes for efficient querying based on metadata attributes and potentially full-text indexes for content-based searches.

In an embodiment, to support multi-tenancy, the content item store 140 implements data isolation and access control mechanisms. These ensure that a tenant's content remains secure and separately accessible. The content item store 140 may utilize partitioning strategies to optimize performance and scalability, distributing content across multiple nodes or storage units based on tenant identifiers or other relevant criteria. Version control capabilities may be integrated, allowing the system to maintain historical snapshots of content items and track changes over time. The content item store 140 interfaces with the hybrid content item chunker 110, providing a stream of raw content for processing and chunking. This interaction may be managed through application programming interfaces (APIs) that support bulk data access and streaming capabilities, enabling efficient data transfer between components. By serving as the authoritative source of original content, the content item store 140 may support data lineage and enables reprocessing or updates to the knowledge database system 120 as chunking algorithms or requirements evolve.

While the environment depicted in FIG. 1 illustrates a multi-tenant provider network 100, one or more embodiments can be effectively implemented in single-tenant environments. In a single-tenant scenario, the components—hybrid content item chunker 110, knowledge database system 120, RAG agent 130, and content item store 140—remain generally functionally equivalent. However, the implementation may differ in resource allocation and data isolation. A single-tenant deployment may dedicate computing resources to a single organization or user, eliminating the need for multi-tenancy management overhead. This dedicated resource model can offer enhanced performance and customization options. The hybrid chunking process remains generally equivalent, utilizing size-based plus semantic chunking and size-based plus layout chunking strategies. The chunk fuser 113 and chunk loader 114 operate on a single tenant's data corpus, allowing for specialized optimizations. In this context, the knowledge database system 120 exclusively indexes content for the single tenant, which may facilitate more tailored indexing strategies. The RAG agent 130, incorporating the LLM 131, can be fine-tuned to the specific domain and use cases of the single tenant, potentially improving response relevance and accuracy.

One or more embodiments combine multi-tenant and single-tenant components, using the advantages of both architectures. In this configuration, for example, the hybrid content item chunker 110 and the knowledge database system 120 may operate as multi-tenant services, serving multiple clients simultaneously. These shared components benefit from economies of scale, distributing computational costs across tenants while maintaining logical data separation. Conversely, the RAG agent 130 and content item store 140 could be implemented as single-tenant instances dedicated to individual clients. This single-tenant approach for sensitive components ensures data privacy and allows for customization of the LLM 131 of the RAG agent 130 to specific domain requirements. The hybrid content item chunker 110 in multi-tenant operation processes content from various sources, applying consistent or tenant-specific chunking strategies across tenants. Meanwhile, the shared knowledge database system 120 indexes these chunks, facilitating efficient retrieval for users. The RAG agent 130, in single-tenant operation, interfaces with the shared knowledge database system 120 but operates on dedicated hardware, ensuring performance isolation. Similarly, the content item store 140 in single-tenant operation provides a secure repository for proprietary data. This hybrid architecture balances resource efficiency with customization and security needs, offering a flexible solution adaptable to various organizational requirements.

### 3. Method for Hybrid Content Item Chunking for Retrieval Augmented Generation

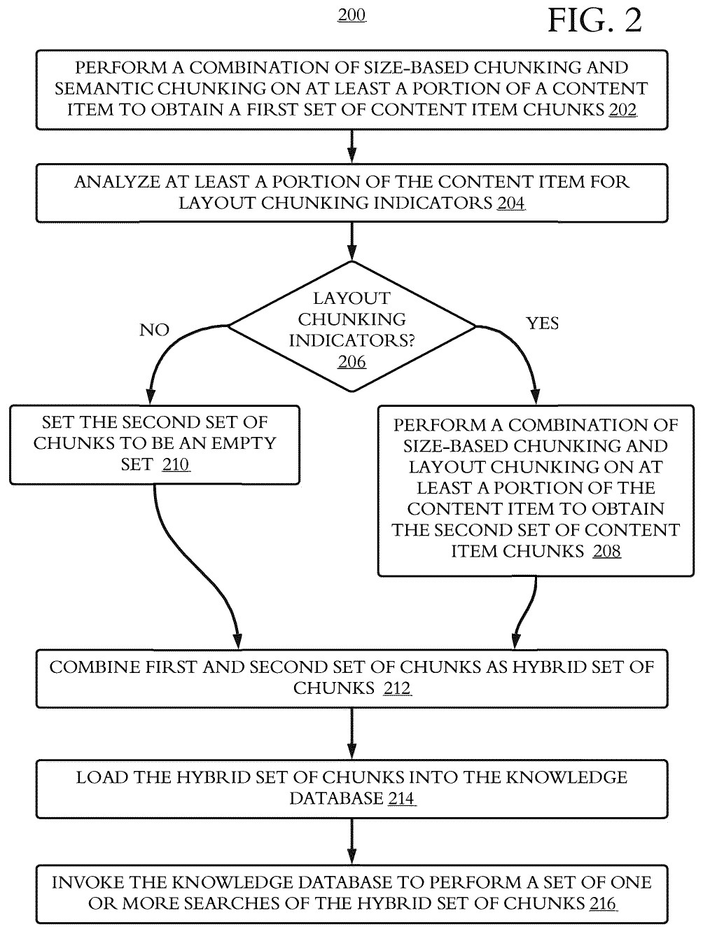

FIG. 2 is a flowchart 200 of a method for hybrid content item chunking for retrieval augmented generation in accordance with an embodiment of the present disclosure. In an embodiment, the method of FIG. 2 is performed by a hybrid content item chunker (e.g., hybrid content item chunker 110 of FIG. 1).

The method encompasses an approach to hybrid content item chunking for retrieval augmented generation. Initially, the hybrid content item chunker applies a combination of size-based and semantic chunking to a portion of the content item, generating a first set of chunks (Operation 202). The content is then analyzed for layout chunking indicators (Operation 204), followed by a determination of whether or not any layout chunking indicators were identified (Operation 206). If layout chunking indicators are found, the hybrid content item chunker derives a set of layout chunking markers from the indicators and performs a combination of size-based and layout chunking to produce a second set of content item chunks (Operation 208). In the absence of layout chunking indicators, the second set is designated as an empty set (Operation 210). The method proceeds to combine the first and second sets of chunks, creating a hybrid set (Operation 212). This hybrid set is subsequently loaded into a database system, optimizing the content for efficient storage and retrieval (Operation 214). The database system is invoked to perform searches within the hybrid chunk set, enabling advanced information retrieval capabilities (Operation 216). This multi-faceted approach captures both semantic meaning and structural layout while maintaining size constraints, resulting in a more comprehensive and nuanced representation of the original content item for enhanced retrieval and processing tasks.

The method employs a dual-strategy approach to content chunking, combining size-based chunking with semantic chunking (Operation 202). Size-based chunking involves segmenting the content into chunks that do not exceed a predetermined size limit, ensuring consistent data unit sizes for efficient processing. Semantic chunking, on the other hand, focuses on creating segments based on the meaning and logical structure of the content. This combined approach aims to balance processing efficiency with content coherence. The operation is performed on at least a portion of a content item, allowing for flexibility in processing partial or complete documents. The result of this operation is a first set of content item chunks that respects both size constraints and semantic boundaries. These chunks serve as units for further processing and analysis in the hybrid chunking method. By employing both strategies simultaneously, the system generates chunks that are optimized for computational handling while preserving the semantic integrity of the content.

Size-based chunking can be implemented through various techniques beyond predefined size constraints. One approach involves dynamic size thresholds that adapt based on content characteristics. For instance, the chunking algorithm could analyze the average sentence or paragraph length within a document and adjust chunk sizes accordingly. This adaptive method ensures chunks remain proportional to the content's natural structure.

Another technique employs overlapping size-based chunks. Instead of creating distinct boundaries, this method allows chunks to share a certain percentage of content with adjacent chunks. The overlap percentage can be fixed or variable, depending on the specific implementation requirements. Overlapping chunks can help preserve context and improve the coherence of extracted information.

Size-based chunking may also incorporate intelligent splitting mechanisms. These mechanisms consider logical break points within the content, such as section headings or paragraph boundaries, while still adhering to size constraints. The algorithm could prioritize these natural divisions when determining chunk boundaries, resulting in more semantically meaningful chunks.

A sliding window approach offers yet another size-based chunking method. This technique involves moving a fixed-size window through the content, creating chunks at regular intervals. The window size can be adjusted based on the content type or specific application needs. Sliding windows can be particularly useful for processing streaming or real-time data.

Lastly, hierarchical size-based chunking presents a multi-level approach to content segmentation. This method creates chunks of varying sizes, organized in a hierarchical structure. Larger chunks contain smaller sub-chunks, allowing for flexible granularity in content analysis and retrieval. Hierarchical chunking can be especially beneficial when dealing with complex or nested document structures.

In an embodiment, the semantic chunking component operates by first segmenting the content item into fundamental grammatical units, such as words or sentences. The chunking algorithm then proceeds to group these units based on semantic relationships. The process adheres to a predefined chunk size limit. This limit serves as a constraint to ensure optimal processing in subsequent stages. The algorithm evaluates the semantic coherence between adjacent grammatical units. Units exhibiting strong semantic connections are kept together within the same chunk. This preservation of semantic relationships aims to maintain context and meaning within a chunk. The chunking process continues until reaching the size limit or encountering a significant semantic break. Semantic relationships are determined through various NLP techniques. These may include analysis of word embeddings, co-occurrence patterns, or semantic similarity measures. By combining size-based constraints with semantic grouping, this approach strikes a balance. The method preserves meaningful content relationships while ensuring chunks remain within practical size limits for downstream processing. This semantic-aware chunking contributes to the overall effectiveness of the hybrid chunking system in retrieval augmented generation applications.

In an embodiment, the semantic chunker employs a recursive character text splitter algorithm to form chunks within the predetermined size limit. The algorithm begins by considering the entire content item or an entire portion of the content item as a single chunk. If this chunk exceeds the size limit, the splitter initiates a recursive division process.

The recursive process first attempts to split the text at the highest level of semantic granularity such as sentence boundaries. If resulting chunks still exceed the size limit, the algorithm recursively applies splitting at finer levels of granularity. These levels may include paragraph breaks, clause boundaries, or individual words.

At a recursive step, the algorithm maintains semantic coherence by prioritizing splits at natural language boundaries. The splitter uses punctuation marks, whitespace patterns, and linguistic markers to identify these boundaries. This approach ensures that semantically related content remains together as much as possible within the size constraints.

The algorithm incorporates a backtracking mechanism to handle cases where a split results in chunks that are too small. In such instances, the splitter may merge adjacent small chunks or adjust split points to optimize chunk size and semantic integrity. This adaptive behavior helps maintain a balance between adhering to size limits and preserving meaningful content relationships.

By recursively applying this splitting strategy, the algorithm can handle various text structures and lengths effectively. The method's flexibility allows it to adapt to different content types while consistently producing semantically coherent chunks within the specified size limitations. This recursive character text splitter approach contributes to the overall efficiency and effectiveness of the hybrid chunking system in retrieval augmented generation applications.

In an embodiment, the semantic chunker utilizes an embedding-based approach with a sliding window mechanism to form chunks within the predetermined size limit. The process begins by converting a grammatical unit (e.g., sentence or paragraph) into a high-dimensional vector representation using a pre-trained language model. These dense vector embeddings capture the semantic essence of units.

The algorithm employs a sliding window that moves across the sequence of embedded grammatical units. For a position of the window, the semantic similarity between adjacent units is calculated. This similarity computation may involve, for example, cosine similarity or dot product operations between the embedding vectors. The sliding window approach allows for efficient local comparisons and helps capture contextual relationships between nearby units.

A predefined similarity threshold serves as the criterion for chunk formation. Adjacent grammatical units whose similarity scores meet or exceed this threshold are classified into the same chunk. This thresholding mechanism ensures that sufficiently related content is grouped together, preserving semantic coherence within chunks.

The chunking process is constrained by the predetermined chunk size limit. As the algorithm groups similar units, it checks the accumulated size of the current chunk. When a chunk approaches the size limit, the process finalizes that chunk and initiates a new one, even if subsequent units meet the similarity threshold. This size constraint helps maintain consistency and manageability in the resulting chunks.

To handle cases where long sequences of highly similar units could potentially exceed the size limit, the algorithm incorporates a forced-split mechanism. This mechanism ensures that chunks adhere to the size constraint while still prioritizing semantic relationships to the greatest extent possible within that limit. The forced split may occur at the point of least semantic disruption within the oversized sequence.

By combining embedding-based similarity calculations with a sliding window approach and size constraints, this method achieves a balance between semantic coherence and practical chunk management. The resulting chunks preserve meaningful relationships between grammatical units while adhering to size limitations

In an embodiment, the semantic chunker employs a model-based approach using BERT and related architectures. The process begins with sentence segmentation of the document, creating a sequence of discrete sentences as the foundation for chunking.

The model-based approach utilizes BERT's Next Sentence Prediction (NSP) capability. A sliding window mechanism feeds pairs of adjacent sentences into the BERT model. The NSP task assesses the likelihood that the second sentence naturally follows the first, providing a measure of semantic continuity. This prediction yields a score indicating the strength of the semantic relationship between the two sentences.

A preset threshold value serves as the decision boundary for chunk segmentation. When the NSP score falls below this threshold, the algorithm identifies a potential segmentation point. This low score suggests a weak semantic link between the sentences, indicating a natural break in the content flow. The chunking process uses these identified break points to delineate semantically coherent chunks within the predetermined size limits.

Additionally, or alternatively, the model-based implementation may incorporate one or more other model architectures to enhance chunking performance. Cross Segment Attention (CSA) mechanisms allow the model to consider broader context beyond immediate sentence pairs. This enables the semantic chunker to capture long-range dependencies and thematic consistency across larger portions of the document. The integration of Sequential Models (Seq Model) may add a layer of sequential understanding to the chunking process. These models can learn and predict patterns in the sequence of sentences, potentially identifying higher-level discourse structures that inform optimal chunk boundaries within predetermined size limits.

In an embodiment, the semantic chunker employs an LLM approach to achieve content segmentation. The LLM uses its deep understanding of language and context to construct propositions from the input text. These propositions represent atomic units of meaning, distilling complex sentences or paragraphs into their core semantic components.

The chunking process begins with the LLM analyzing the content item and generating a set of propositions. A proposition encapsulates a distinct idea or concept present in the text. The LLM's ability to comprehend nuanced language allows for the extraction of both explicit and implicit propositions, capturing the full semantic richness of the content.

Following proposition construction, the chunker establishes a hierarchical index structure. This structure organizes the propositions in a small-to-big arrangement with the original content serving as the root node. Lower levels of the hierarchy contain more granular propositions, while higher levels represent broader concepts or themes. This multi-level index enables efficient navigation and retrieval of content at various levels of semantic granularity.

The chunking algorithm traverses this hierarchical structure to form semantically coherent chunks with the predetermined size limit. Starting from the lowest level, the system aggregates propositions while adhering to the predetermined chunk size limit. As the chunker moves up the hierarchy, it considers broader semantic relationships, ensuring that related propositions are grouped together when possible.

This LLM-based approach offers several advantages for semantic chunking. The use of propositions allows for more precise semantic segmentation compared to methods based solely on sentence or paragraph boundaries. The hierarchical index structure facilitates the creation of chunks that maintain semantic coherence across multiple scales, from fine-grained details to overarching themes.

Furthermore, the LLMs contextual understanding enables the chunker to handle complex linguistic phenomena, such as coreference, implicit information, and domain-specific terminology. This sophisticated language processing results in chunks that more accurately reflect the semantic structure of the content, improving the overall quality of the segmentation.

By using the power of LLMs to construct propositions and form a small-to-big index structure, this semantic chunking method achieves a high degree of refinement in content segmentation. The resulting chunks exhibit strong internal semantic consistency while maintaining relationships to broader themes within the document. This approach significantly enhances the capabilities of the hybrid chunking system, potentially leading to more effective retrieval and generation in downstream applications.

In this embodiment, the semantic chunker employs a streamlined approach utilizing the BERT language model. The process begins with a preprocessing step that segments the content item or a portion thereof into individual sentences. This sentence-level granularity serves as the foundation for subsequent semantic analysis.

The BERT model, pre-trained on vast corpora of text data, functions as the semantic analysis engine. BERT's bidirectional nature allows it to consider context from both directions, enabling a nuanced understanding of sentence relationships. The model scans through the sequence of sentences, analyzing a pair of adjacent sentences to determine their semantic similarity or topical continuity.

For a pair of adjacent sentences, BERT generates a similarity score. This score quantifies the degree to which the two sentences belong to the same domain or topic. The scoring mechanism leverages BERT's deep contextual understanding, considering various factors, such as shared vocabulary, thematic consistency, and logical flow between the sentences.

A predetermined threshold value serves as the decision boundary for chunk segmentation. The chunking algorithm compares BERT's predicted similarity score for a sentence pair against this threshold. Scores falling below the threshold indicate a potential topic shift or semantic discontinuity, marking these points as candidates for text segmentation.

The chunking process aggregates sentences into coherent chunks based on these similarity assessments within the predefined chunk size limit. Sentences with above-threshold similarity scores are grouped together, forming semantically consistent segments. When a below-threshold score is encountered, the current chunk is finalized, and a new chunk begins with the subsequent sentence.

This simplified BERT-based approach offers a balance between semantic sophistication and computational efficiency. By focusing on pairwise sentence comparisons, the method captures local semantic relationships without the need for more complex hierarchical or global analyses. The use of a pre-trained BERT model allows for robust semantic understanding without requiring domain-specific training.

The resulting chunks exhibit strong internal semantic coherence while adhering to the predetermined size limits. This method's relatively straightforward nature makes it particularly suitable for scenarios requiring rapid processing of large volumes of text, where the trade-off between semantic precision and processing speed favors efficiency.

By leveraging BERT's powerful language understanding capabilities in a streamlined manner, this semantic chunking approach contributes to the overall effectiveness of the hybrid chunking system. The method's ability to identify meaningful semantic boundaries enhances the quality of chunks for subsequent retrieval and generation tasks in the broader context of the retrieval augmented generation system.

The hybrid content item chunker analyzes the content item, or a selected portion thereof, for layout chunking indicators (Operation 204). This operation examines the structural and formatting elements of the document to identify potential segmentation points based on visual or organizational cues. The analysis process employs a combination of pattern recognition techniques and heuristic rules to detect various layout indicators.

Common layout chunking indicators include headings, subheadings, page breaks, section dividers, and changes in formatting styles. The analysis may also consider more subtle cues, such as indentation patterns, bullet points, or numbered lists. In digital documents, the process might examine HTML tags, CSS classes, or XML elements that denote structural divisions.

The analysis algorithm traverses the content item, either sequentially or using a tree-based representation of the document structure. As the algorithm progresses, it maintains a record of identified layout indicators, noting their type, position, and hierarchical relationships. This information forms the basis for subsequent layout chunking operations.

For text-heavy documents, the analysis may employ NLP techniques to distinguish between body text and structural elements. In multi-modal content, the process may involve image analysis to detect visual separators or changes in graphical layout.

The outcome of this analysis step is a set of zero or more layout chunking markers (Operation 206). These markers serve as candidate points for segmenting the content based on its visual or logical structure. The identified indicators may not be definitive chunking points but rather serve as input for the subsequent determination and chunking operations.

By incorporating layout analysis into the hybrid chunking method, the hybrid content item chunker can produce chunks that follow with the document's inherent structure within the predetermined size limit. This results in more intuitive and contextually relevant segmentation, enhancing the effectiveness of downstream retrieval and generation tasks in the broader retrieval augmented generation system.

In an embodiment, the content item, or a portion thereof, is specifically a markdown document or is covered to a markdown document by a pre-processing operation, and the layout chunking process utilizes a markdown text splitter designed to analyze and segment markdown based on their inherent structure, leveraging the syntax of markdown to identify meaningful layout boundaries.

The markdown text splitter begins by parsing the entire markdown document, recognizing various markdown elements as potential layout chunking indicators. These elements include headers of different levels (denoted by #, ##, ###, etc.), horizontal rules ( - - - ), code blocks (''' or indented text), blockquotes (>), and list structures (both ordered and unordered).

Headers serve as primary layout chunking markers, with the splitter treating a header and its associated content as a distinct chunk. The level of the header (e.g., H1, H2, H3) informs the hierarchical structure of the resulting chunks, allowing for nested relationships between sections and subsections.

The splitter employs a recursive strategy to handle nested markdown structures. For instance, when encountering a list within a section, the algorithm may create sub-chunks for a list item while maintaining the overall section as a parent chunk. This approach preserves the document's logical structure in the resulting chunk hierarchy.

The markdown text splitter also considers special markdown syntax for more advanced layout indicators. These may include YAML Ain't Markup Language (YAML) front matter (metadata at the beginning of the document) or the like, custom HyperText Markup Language (HTML) embedded within the markdown, or special comment syntax used for sectioning.

The chunking process respects the predefined chunk size specified in the hybrid chunking method. When a markdown section exceeds this size limit, the splitter may employ additional heuristics to create logical break points, such as splitting at paragraph boundaries or after a certain number of list items.

By leveraging the markdown text splitter, this embodiment achieves layout chunking that is attuned to the structure of markdown documents. The resulting layout chunks closely mirror the document's original organization, facilitating more intuitive and context-aware retrieval in subsequent stages of the retrieval augmented generation process.

This markdown-specific approach enhances the overall hybrid chunking method by providing layout chunks that are semantically meaningful and structurally coherent. The method's ability to interpret markdown syntax allows for handling documents with complex nested structures, tables, and mixed content types, while maintaining the document's original hierarchical relationships.

In an embodiment, the content item is an HTML or similar markup language document, and the layout chunking process utilizes a splitter that is designed to analyze and segment HTML documents based on their hierarchical structure, with a particular focus on header elements as primary chunking indicators.

The splitter begins by parsing the HTML document and identifying header tags (h1, h2, h3, etc.) as structural elements. These headers serve as natural segmentation points, delineating major sections and subsections within the document. The splitter traverses the Document Object Model (DOM) tree, creating chunks based on the content between successive headers.

A feature of this splitter is its ability to generate metadata for a chunk. As the document is segmented, the splitter associates relevant header information with a resulting chunk. This metadata typically includes the header text, its level in the document hierarchy, and potentially its position or order in the overall structure. The inclusion of metadata enhances the contextual understanding of a chunk, facilitating more nuanced retrieval and processing in later stages.

The splitter offers flexibility in its output format. It can return individual chunk elements, containing the text content between headers along with its associated metadata. Alternatively, the tool can combine elements, creating larger chunks that encompass multiple sections, while still retaining the pertinent metadata for an included section. This flexibility allows for fine-tuning of chunk granularity based on specific application requirements.

The splitter employs a recursive strategy to handle nested HTML structures. When encountering nested headers (e.g., an h3 within an h2 section), the splitter maintains the hierarchical relationships, potentially creating sub-chunks that preserve the document's logical organization. This nested approach ensures that the resulting chunks reflect the original document's structure and information hierarchy.

The chunking process adheres to a predefined chunk size specified in the hybrid chunking method. When a section delineated by headers exceeds this size limit, the splitter may employ additional heuristics. These could include breaking at paragraph boundaries, list items, or other semantic HTML elements to create logical split points while staying within size constraints.

By leveraging the splitter, this embodiment achieves layout chunking that is attuned to the structure of HTML and other markup language documents. The resulting layout chunks closely mirror the document's original organization with the added benefit of rich metadata. This approach enhances the overall hybrid chunking method by providing layout chunks that are structurally coherent and carry important contextual information.

The method's handling of HTML structure, combined with its metadata generation capabilities, makes it particularly well-suited for complex web documents or content management system outputs. The rich, structure-aware chunks produced by this process can greatly improve the accuracy and relevance of subsequent retrieval and generation tasks in the broader retrieval augmented generation system.

When layout chunking indicators have been identified in the content item, the hybrid content item chunker determines layout chunking markers and performs a combined size-based and layout-based chunking, for example, by using one or more of the layout chunking processes described above (Operation 208).

The process begins by translating the identified layout chunking indicators into a set of definitive layout chunking markers. These markers serve as concrete points for segmenting the content based on its structural or visual layout. The determination of markers might involve filtering, prioritizing, or combining the initial indicators to create a coherent set of chunking points. For instance, in a document with multiple levels of headers, the system might select the top-level headers as primary chunking markers.

Once the layout chunking markers are established, the method proceeds to perform a dual chunking approach. This approach combines size-based chunking with layout-based chunking, creating a balance between consistent chunk sizes and respect for the document's inherent structure. The size-based constraint ensures that no chunk exceeds a predetermined length, which is useful for maintaining efficiency in downstream processing tasks.

The layout-based aspect of the chunking process uses the determined markers as primary split points. The algorithm traverses the content, initiating new chunks at a marker location. This approach preserves the document's logical structure in the resulting chunks, potentially improving the contextual relevance of a segment.

When a chunk defined by layout markers exceeds the size-based limit, the algorithm employs additional splitting strategies. These may include breaking at the nearest sentence boundary, paragraph end, or other logical points within the oversized section. This ensures adherence to the size-based constraint while minimizing disruption to the content's semantic flow.

The outcome of this operation is a second set of content item chunks that reflect both the document's layout structure and the size-based requirements. These chunks are distinct from the first set produced by semantic chunking, offering an alternative segmentation of the content based on its visual or structural organization.

By incorporating both layout and size considerations, this step of the hybrid chunking method produces chunks that are well-suited for efficient processing while maintaining alignment with the document's original structure. This dual approach enhances the versatility of the resulting chunk set, potentially improving the performance of subsequent retrieval and generation tasks in the broader context of retrieval augmented generation systems.

In an embodiment, the hybrid content item chunker determines that the analysis process failed to identify any layout chunking markers within the content item or a portion thereof (Operation 206). When no layout chunking markers are detected, the hybrid content item chunker explicitly sets the second set of content item chunks to an empty set (Operation 210). By assigning an empty set rather than leaving the second set undefined or null, the hybrid content item chunker ensures that subsequent operations have a valid, albeit empty, set to work with. The absence of layout chunking markers can occur in various situations. Documents with minimal structural formatting, plain text files, or content items where layout indicators are too subtle or non-standard to be recognized by the analysis algorithm may result in this scenario. Additionally, certain types of content, such as transcripts or unformatted data dumps, might naturally lack discernible layout markers. Setting the second set to an empty set in these cases allows the hybrid chunking method to gracefully handle a wide range of content types. This effectively reduces the hybrid method to rely solely on the first set of chunks (derived from size-based and semantic chunking) when layout-based chunking is not applicable or possible.

The hybrid content item chunker merges the two distinct sets of content item chunks to create a unified, hybrid set (Operation 212). Specifically, the first set of chunks, derived from size-based and semantic chunking, is combined with the second set, which results from layout-based chunking, if applicable. This combination operation synthesizes the outputs from different chunking strategies, capturing unique aspects of the content's structure and meaning. The resulting hybrid set incorporates the strengths of multiple chunking approaches, potentially offering a more comprehensive and nuanced representation of the original content.

In an embodiment of, the combination process by the hybrid content item chunker incorporates a deduplication mechanism to eliminate redundant content item chunks (Operation 212). The hybrid content item chunker first aggregates the first and second sets of chunks into a unified collection. Subsequently, a deduplication algorithm is applied to this aggregate set. The algorithm compares a chunk against others, identifying identical or highly similar content. Similarity can be determined using various methods, such as hash functions, string matching algorithms, or semantic similarity measures. Chunks exceeding a predefined similarity threshold are flagged as duplicates. The hybrid content item chunker then selectively removes duplicate chunks, retaining one instance of a unique content segment. This deduplication process ensures the final hybrid set contains diverse, non-redundant chunks. By eliminating duplicates, the hybrid content item chunker optimizes storage efficiency and reduces computational overhead in subsequent retrieval operations. The deduplication step also mitigates potential biases in search results that could arise from overrepresentation of certain content segments. Consequently, the resulting hybrid set offers a more balanced and efficient representation of the original content, enhancing the overall performance of the retrieval augmented generation system.

In an embodiment, the combination process prioritizes layout-based chunks over semantic chunks when both correspond to the same portion of the content item (Operation 212). The hybrid content item chunker first aligns chunks from both sets based on their position in the original content. When overlapping chunks are identified, the layout-based chunk takes precedence and replaces the semantic chunk in the final hybrid set. This prioritization stems from the assumption that layout-based chunking often better preserves the document's structural integrity and contextual boundaries.

For example, consider a scientific paper with a methods section. The semantic chunking might split this section based on sentence or paragraph boundaries, potentially separating closely related procedural steps. In contrast, layout-based chunking might keep the entire methods section intact, preserving its structural cohesion. In the combination step, the layout chunk encompassing the whole methods section would override any semantic chunks derived from the same content (Operation 212).

This approach ensures that the final hybrid set maintains useful structural elements of the content item while still benefiting from semantic chunking in areas where layout indicators are absent or less significant. The resulting hybrid set thus combines the strengths of both chunking methods, potentially improving the retrieval augmented generation system's ability to maintain context and structural relevance in its outputs.

In an embodiment, the process of loading the hybrid set of content item chunks into a database system involves several technical operations (Operation 214). Initially, the hybrid content item chunker prepares the hybrid chunks for database insertion by standardizing their format and structure. A chunk may be assigned a unique identifier, which may be a hash of its content or a sequential number. Metadata may be appended to a chunk, including various information, such as the chunk's position in the original document, its creation timestamp, and the chunking method used to generate it.

The hybrid content item chunker creates appropriate tables or collections in the database to store the chunk data and associated metadata. Indexing strategies are implemented to facilitate efficient retrieval, potentially utilizing full-text search capabilities, inverted indices, or vectors/embeddings. The actual insertion of chunks may occur in batches to optimize performance with the hybrid content item chunker employing bulk insert operations where possible. During this process, the database may also generate additional indices or update existing ones to maintain query efficiency.

One or more components conduct a set of searches on the hybrid content chunks stored in the database (Operation 216). For example, a RAG agent may submit a search request to the database. This request typically contains a query string and potentially additional parameters, such as relevance thresholds or result limits.

Upon receiving the request, the database translates the query into a format compatible with the database's query language. This translation may involve query expansion, applying synonyms or related terms to broaden the search scope. The system then invokes the database's search functionality, which could utilize techniques, such as full-text search, vector similarity search, or a combination of both.

For example, consider a RAG agent tasked with answering questions about climate change. The agent might submit a query like “recent global temperature trends”. The system would parse this query, potentially expanding it to include terms like “climate warming patterns” or “temperature anomalies”. The database search would then retrieve relevant chunks, possibly employing a combination of keyword matching and semantic similarity scoring.

The database executes the search across the hybrid set of chunks, leveraging both the semantic and layout-based information encoded in the chunks. Results are ranked based on relevance scores, which may consider various factors, such as term frequency, chunk position, and structural importance derived from layout information. The RAG agent or the database may perform multiple searches with varying parameters to ensure comprehensive coverage of the hybrid chunk set.

Finally, the search results are aggregated, filtered for duplicates, and returned to the RAG agent. These results, comprising the most relevant chunks, serve as the augmented context for the agent's subsequent generation task, enabling more informed and accurate responses to the original query.

### 4. Example Chunking Process

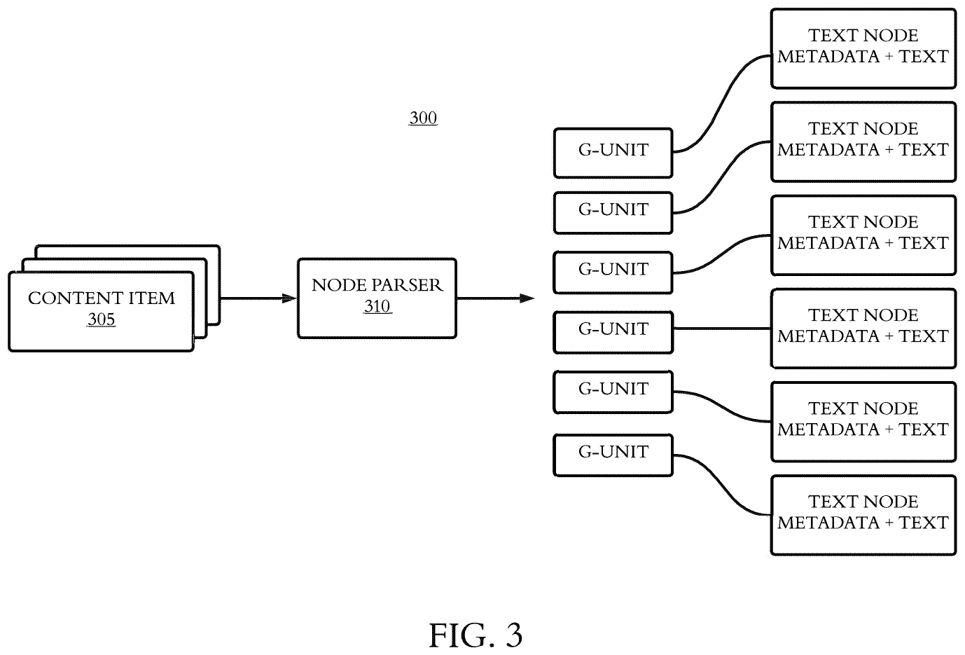

FIG. 3 illustrates an example chunking process 300 according to an embodiment of the present disclosure. In one or more embodiments, the node parser 310 processes a segment of the content item 305 to generate grammatical units (g-units). A g-unit is transformed into a text node, which encapsulates both the textual content and associated metadata. The metadata includes useful information, such as the content item identifier and the g-unit's position within the original content. This facilitates precise tracking and referencing of a textual component.

The node parser 310 employs NLP techniques to identify and delineate grammatical structures. These techniques may include part-of-speech tagging, dependency parsing, and syntactic analysis. The resulting g-units represent coherent linguistic elements, which could range from phrases to sentences or paragraphs, depending on the granularity of the parsing algorithm.

Once the g-units are established, one or more embodiments generate corresponding text nodes. A text node serves as a container, containing the raw text of the g-unit alongside its metadata. The content item identifier in the metadata provides traceability back to the source document. The positional information preserves the original context and sequence of the textual elements. This metadata maintains contextual relevance during subsequent processing steps.

One or more embodiments apply a size-based constraint to ensure no chunk exceeds a predefined token limit. This limit may be set based on the capabilities of downstream AI models or embedding generation processes. Concurrently, the semantic chunking algorithm analyzes the textual content of a node, leveraging NLP techniques to identify coherent semantic units.

One or more embodiments begin by aggregating adjacent text nodes, continuously checking against the size-based threshold. When a potential chunk approaches this limit, semantic analysis comes into play. The algorithm evaluates the semantic cohesion of the aggregated nodes, looking for natural break points that preserve meaning and context. This process may involve various techniques, such as topic modeling, semantic similarity measures, or discourse analysis to determine optimal chunk boundaries.

As the chunking process progresses, one or more embodiments maintain the metadata associated with a text node. This preservation of metadata allows for the creation of chunks that respect size constraints and semantic coherence as well as retain useful information about their origin and position within the content item. The resulting chunks, therefore, encapsulate both the textual content and the contextual information necessary for accurate retrieval and processing in later stages.

One or more embodiments involve a combination of layout-based and size-based chunking strategies. Initially, one or more embodiments analyze the metadata of a text node to identify layout chunking markers. These markers may include HTML tags, Markdown formatting, or other structural indicators preserved in the node metadata. The system then uses these markers to delineate potential chunk boundaries, prioritizing document structure over semantic content.

One or more embodiments aggregate text nodes sequentially, respecting the layout markers as primary break points. When a layout marker is encountered, such as a heading or a new section indicator, one or more embodiments initiate a new chunk. This approach ensures that the resulting chunks align closely with the content item 305's original structure. Concurrently, the size-based constraint is applied to prevent any chunk from exceeding a predefined token or byte limit.

If a layout-defined section approaches or exceeds the size-based, one or more embodiments implement a splitting mechanism. This mechanism may involve finding the nearest sentence boundary or another suitable break point within the section. The splitting process aims to maintain as much of the original layout structure as possible while adhering to size limitations. Throughout this process, one or more embodiments preserve the hierarchical relationships between chunks, potentially using nested structures to represent subsections within larger document divisions.

One or more embodiments also consider the relative importance of different layout markers. For instance, top-level headings might always trigger a new chunk, while lower-level formatting elements could be treated more flexibly. This hierarchical approach to layout markers allows for a nuanced representation of the document's structure in the resulting chunks.

As the chunking progresses, one or more embodiments continuously update and carry forward relevant metadata. This metadata includes information about the chunk's position in the original document, its relationship to other chunks, and any significant layout features it contains. The preservation of this contextual information enables more retrieval and processing in subsequent stages of the RAG system.

The output of this process is a set of content item chunks that closely mirror the original content item 305's layout while respecting size-based constraints. These chunks capture the structural essence of the content item, providing a complementary perspective to the semantically driven chunks. The layout-based approach is useful for documents where visual organization plays a crucial role in conveying information hierarchy and relationships.

### 5. Chunking Evaluation

In an embodiment, an evaluation approach is performed to assess the effectiveness of various chunking strategies of the hybrid content item chunker. The evaluation approach treats the entire RAG agent as a functional module that processes chunks produced by a data ingestion pipeline. The evaluation approach employs two primary metrics, the retrieval score and the generation score.

The retrieval score quantifies the RAG agent's ability to fetch relevant documents. Specifically, this metric measures how often ground-truth documents appear within the top k results for given queries submitted by the RAG agent. A higher retrieval rate indicates superior performance in delivering pertinent information.

The generation score, on the other hand, focuses on the quality of the RAG agent's outputs. This score is calculated as the ratio of generated responses that satisfy both answerability and grounding criteria to the total number of generated responses in a benchmarking dataset. Answerability assesses if the generated response adequately addresses the query, while grounding evaluates if the response is supported by information within the retrieved content item.

By combining these metrics, the RAG agent score serves as an end-to-end performance indicator. This composite score reflects the RAG agent's overall efficacy across different chunking strategies implemented in the hybrid content item chunker. The evaluation approach thus provides a holistic view of how chunking strategies impact both retrieval accuracy and response quality, offering valuable insights for optimizing the RAG agent's performance.

In an embodiment, an implementation of the hybrid document chunking system incorporates a feedback loop for continuous improvement. The system computes performance scores for the hybrid set of document chunks, such as retrieval and generation scores. These scores quantify the effectiveness of the current chunking strategy. Based on these performance metrics, the system employs an automatic modification process. This process involves machine learning algorithms or heuristic-based adjustments to fine-tune the chunking parameters. The modification could target various aspects of the chunking process, such as adjusting a predefined chunk size, refining semantic segmentation rules, or optimizing layout-based chunking criteria. The modified hybrid document chunking system, resulting from these automated adjustments, is then applied to chunk new content items.

In an embodiment, the retrieval score performance metric is used to evaluate the hybrid document chunking system. This score quantifies the effectiveness of the system in retrieving relevant document chunks from the database. Specifically, the retrieval score measures the frequency with which chunks corresponding to ground-truth content are successfully retrieved in response to queries submitted by a RAG agent.

A set of predefined queries representative of typical user inquiries is used to assess the system's retrieval capabilities. Ground-truth content refers to pre-identified sections of content items that are known to contain accurate and relevant information for these queries. The retrieval score is calculated as a rate, proportion, or percentage of successful retrievals across multiple queries.

By focusing on the system's ability to surface ground-truth content, the retrieval score provides a quantitative measure of the chunking strategy's effectiveness in preserving and making accessible the most relevant information. This score serves as a useful indicator for assessing and iteratively improving the hybrid document chunking system's performance in supporting RAG processes.

In an embodiment, a generation score is used as a performance metric for the hybrid document chunking system. This score evaluates the quality of responses produced by a RAG agent using the hybrid set of content item chunks. The generation score is computed through a two-step process that assesses both the relevance and accuracy of the generated responses.

In the first step, the RAG agent generates a set of responses to a predefined set of queries. These responses are created using one or more chunks from the hybrid set, demonstrating how effectively the chunking strategy supports the generation process. The second step involves a qualitative assessment of these generated responses. A response is evaluated based on two criteria, valid answerability and grounding. Valid answerability checks if the response appropriately addresses the query, while grounding ensures the response is supported by information within the ground truth content items.

The generation score is then calculated as the proportion of responses that satisfy both criteria. This metric provides a quantitative measure of the chunking strategy's effectiveness in supporting accurate and relevant response generation. By assessing both answerability and grounding, this score offers insights into how well the hybrid chunking approach preserves context and supports the RAG agent in producing high-quality, informative responses.

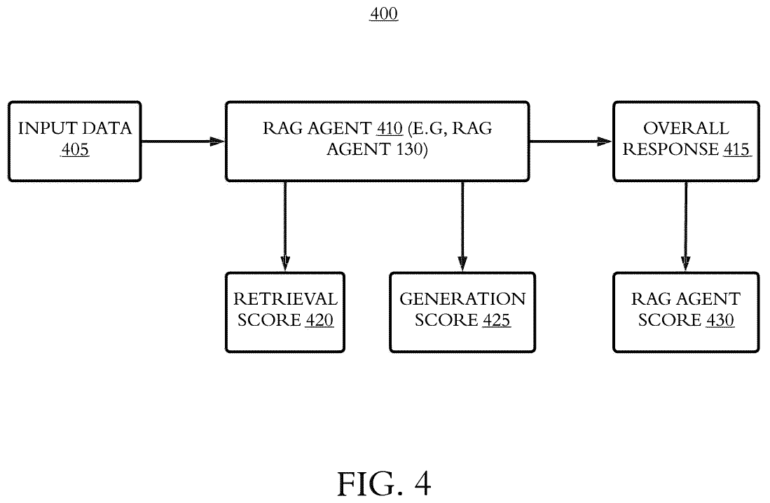

FIG. 4 depicts a system 400 for evaluating a hybrid chunking process within a RAG framework according to an embodiment of the present disclosure. The evaluation utilizes a set of input data 405, comprising RAG agent queries paired with corresponding ground truth data. The RAG agent 410 processes a query by retrieving relevant chunks from a knowledge database system, where these chunks have been pre-generated using the hybrid chunking process under evaluation.

The RAG agent 410 employs a Reason+Act framework to generate intermediate responses based on the retrieved chunks. Subsequently, the RAG agent 410 produces an overall response 415 to the query. The evaluation process assesses three key metrics for a query: retrieval score 420, generation score 425, and RAG agent score 430.

The retrieval score 420 quantifies the RAG agent 410's ability to fetch chunks within the top-k ground truth chunks associated with the query. This score can be calculated using precision, recall, or F1 metrics, considering true positives, false positives, and false negatives in the retrieved chunks.

The generation score 425 is computed as the ratio of intermediate responses that exhibit both valid answerability and grounding to the total number of intermediate responses generated. Grounding is determined by the semantic similarity between the intermediate response and the retrieved chunks, while valid answerability is assessed by the semantic similarity between the intermediate response and the query. Both assessments utilize latent space representations and similarity measures compared against predefined thresholds.

The RAG agent score 430 measures the semantic similarity between the actual overall response 415 and the ground truth response for a query. This score is calculated using latent space representations of both responses and a similarity measure such as cosine similarity.

These metrics collectively provide a comprehensive evaluation of the hybrid chunking process, assessing retrieval accuracy, response quality, and overall performance of the hybrid chunking process. The evaluation framework enables fine-tuning and optimization of the chunking process to enhance the RAG agent 410's effectiveness in information retrieval and response generation.

The Reason+Act framework, as applied in the context of FIG. 4, is a structured approach for generating intermediate responses by the RAG agent 410. This framework consists of two primary stages, Reason and Act. In the Reason stage, the RAG agent 410 analyzes the retrieved chunks and the original query, employing NLP techniques to understand the context and formulate a logical approach to answering the query. This reasoning process may involve identifying key information, drawing connections between different chunks, and inferring relevant conclusions.

Following the Reason stage, the Act stage involves generating the actual intermediate response based on the reasoning outcomes. During this phase, the RAG agent 410 synthesizes the information and insights derived from the Reason stage into a coherent and relevant response. The Act stage may utilize various generation techniques, such as abstractive summarization or controlled text generation, to produce responses that are both informative and contextually appropriate.

The Reason+Act framework enables the RAG agent 410 to generate multiple intermediate responses for a query, potentially exploring different aspects or interpretations of the retrieved information. This approach allows for an exploration of the query space, potentially leading to more robust and diverse final responses.

In the context of FIG. 4, an LLM can be employed for semantic similarity determinations, enhancing the evaluation process of the hybrid chunking system. The LLM's deep understanding of language and context makes it suited for generating and comparing latent space representations of text. When assessing the grounding of intermediate responses or their valid answerability, the LLM can process both the response and the relevant text (retrieved chunks or query) to produce high-dimensional semantic embeddings. The LLM can then calculate similarity measures, such as cosine similarity, between these embeddings. This approach allows for a comparison that accounts for contextual nuances, synonyms, or implicit relationships between concepts.

The retrieval score 420, generation score 425, and RAG agent score 430 collectively provide a comprehensive evaluation of the hybrid chunking process when applied to the set of input data 405. These scores offer insights into different aspects of the RAG agent 410's performance, allowing for an assessment of the chunking process's effectiveness.

The retrieval score 420 directly reflects the quality of the chunk generation and retrieval process. A consistently high retrieval score 420 across the input data set 405 indicates that the hybrid chunking method effectively segments content into retrievable units that align well with user queries. The retrieval score 420 helps evaluate the chunking process's ability to preserve context and relevance within individual chunks.

The generation score 425 assesses the RAG agent 410's ability to produce intermediate responses that are both grounded in the retrieved information and validly answer the query. The generation score 425 indirectly evaluates the chunking process by measuring how well the retrieved chunks support the generation of accurate and relevant responses. A high generation score 425 suggests that the chunks contain sufficient and appropriate information for the RAG agent 410 to reason effectively.

The RAG agent score 430 provides an overall measure of the hybrid chunking performance by comparing the final output to ground truth responses. The RAG agent score 430 reflects the cumulative impact of the chunking process, retrieval mechanism, and response generation. A high RAG agent score 430 indicates that the entire pipeline, including the chunking process, is operating to produce accurate and relevant responses.

By analyzing these scores across the set of input data 405, evaluators can identify patterns and potential areas for improvement in the hybrid chunking process. For instance, a high retrieval score 420 coupled with a low generation score 425 might suggest that the chunking process is effective for retrieval but may be creating chunks that are too granular for coherent response generation. Conversely, a low retrieval score 420 but a high generation score 425 and a high RAG agent score 430 could indicate that the chunking process needs refinement to improve initial retrieval even though the RAG agent 410 compensates well in later stages.

Furthermore, examining the distribution and correlation of these scores across different query types or content domains within the input data set 405 can reveal the chunking process's strengths and weaknesses in handling various scenarios.

### 6. EXAMPLE EMBODIMENT

A detailed example is described below for purposes of clarity. Components and/or operations described below should be understood as one specific example which may not be applicable to certain embodiments. Accordingly, components and/or operations described below should not be construed as limiting the scope of any of the claims.

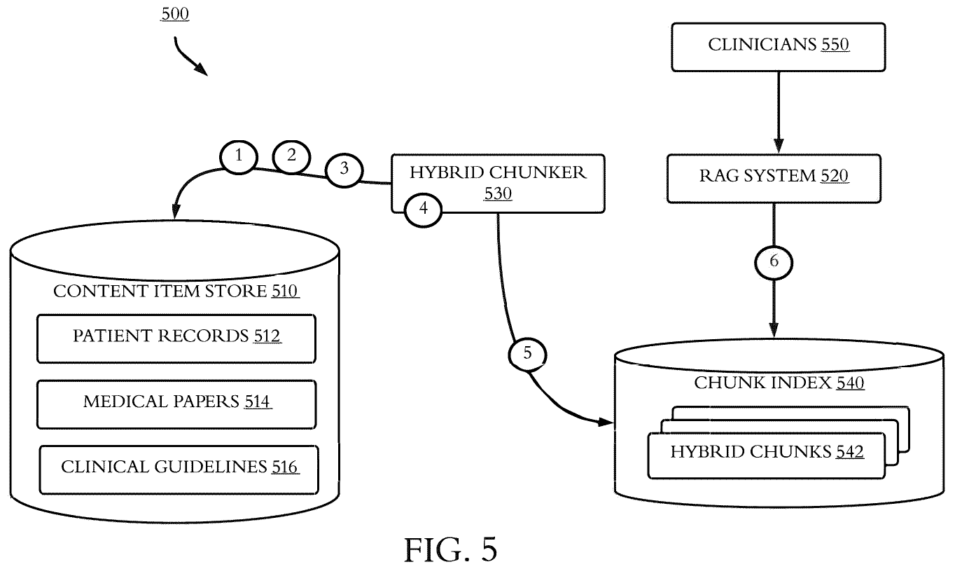

FIG. 5 illustrates an example of hybrid content item chunking for retrieval augmented generation in accordance with an embodiment of the present disclosure. Specifically, FIG. 5 illustrates an example operation 500 of an enterprise-level healthcare organization that manages vast amounts of patient records 512, medical research papers 514, and clinical guidelines 516 in a content item store 510 (which may be implemented by multiple database systems). To improve information retrieval and support clinical decision-making, the organization implements one or more embodiments to enhance its Retrieval Augmented Generation (RAG) system 520. The hybrid chunker 530 begins by performing a combination of size-based chunking and semantic chunking on portions of the medical content items 512, 514, and 516, generating a first set of content item chunks (Operation 1). This ensures that a chunk remains within optimal size limits for processing while preserving semantic relationships useful for medical context.

Subsequently, the hybrid chunker 530 analyzes the content items 512, 514, and 516 for layout chunking indicators such as headings, subheadings, tables, and bullet points to identify a set of layout chunking markers (Operation 2). Based on these markers, the hybrid chunker 530 performs a combination of size-based chunking and layout chunking to obtain a second set of content item chunks that maintain the structural integrity of the documents (Operation 3).

The first and second sets of content item chunks are then combined to create a hybrid set 542 that incorporates both semantic meaning and structural layout elements (Operation 4).

This hybrid set 542 is loaded into a database system (referred to as chunk index 540) designed for rapid search operations (Operation 5). The organization's RAG system 120 invokes the chunk index 540 to perform searches on the hybrid set of content item chunks 542 when clinicians 550 input queries. By utilizing this method, the RAG system 520 delivers more accurate, contextually relevant information, aiding physicians in making informed decisions and enhancing patient care outcomes.

In the enterprise healthcare setting, the hybrid chunker 530 initiates the hybrid chunking process by applying a dual-pronged approach to content segmentation. Size-based chunking is employed to ensure that no individual chunk exceeds the optimal token limit for the RAG system 520's underlying language model. Concurrently, semantic chunking is utilized to preserve the contextual integrity of medical concepts and relationships. This combined method is applied to the corpus of medical documents 512, 514, and 516 in the content item store 510. The corpus includes patient electronic health records 512, clinical trial reports 516, and medical research papers 514. Natural Language Processing (NLP) techniques, such as sentence boundary detection and named entity recognition, are used by the hybrid chunker 530 to identify semantically cohesive units within the text. The hybrid chunker 530 subdivides or combines the units to adhere to the size-based constraints. The resulting first set of content item chunks maintains a balance between size efficiency and semantic relevance.

At Operation 2, the hybrid chunker 530 focuses on layout analysis of the medical documents. The hybrid chunker 530 employs document structure recognition algorithms to identify layout chunking indicators. These indicators include hierarchical headings, subheadings, table structures, bulleted and numbered lists, and paragraph demarcations. Machine learning models, trained on annotated medical documents, are utilized to recognize domain-specific layout patterns. The models identify section breaks in clinical guidelines, tabular data in lab reports, and structured abstracts in research papers. NLP techniques are applied to differentiate between body text and metadata elements such as footnotes or citations. The hybrid chunker 530 also implements optical character recognition (OCR) and layout parsing for scanned documents, ensuring comprehensive analysis across all document types. This examination results in a set of layout chunking markers. These markers serve as reference points for the subsequent layout-based chunking process. The identified markers are stored with their corresponding positional metadata, facilitating precise segmentation in the following operation.

Building upon the layout analysis, the hybrid chunker 530 proceeds to Operation 3 which involves a combination of size-based chunking and layout-based segmentation. Utilizing the previously identified layout chunking markers, the hybrid chunker 530 implements a hierarchical chunking algorithm. This algorithm respects the document's inherent structure while adhering to predefined size constraints. Major sections, delineated by top-level headings, form the primary chunking boundaries. Subsections, tables, and list structures are treated as cohesive units within these larger chunks. The size-based constraint is applied dynamically, splitting larger sections when necessary while preserving the integrity of smaller, self-contained elements. A custom tokenization method, tailored for medical terminology, ensures accurate size estimation. The hybrid chunker 530 employs a sliding window approach to handle overlapping content, allowing for context preservation at chunk boundaries. This process generates a second set of content item chunks that balances structural fidelity with size optimization. The resulting chunks maintain the logical flow and visual hierarchy of the original documents.

At Operation 4, the hybrid chunker 530 implements a merging algorithm to combine the first and second sets of content item chunks. This process creates a hybrid set 542 that leverages the strengths of both semantic and layout-based chunking. The merging algorithm employs a hierarchical overlap detection mechanism to identify and reconcile duplicate or overlapping content across the two sets. Priority is given to chunks that preserve critical semantic relationships while also respecting significant layout boundaries. A conflict resolution protocol handles cases where semantic and layout-based chunks diverge significantly. This protocol uses a scoring system that weighs factors such as semantic coherence, structural integrity, and chunk size optimality. Machine learning techniques, including clustering and classification models, are applied to determine the most effective chunk boundaries in ambiguous cases. The resulting hybrid set of content item chunks 542 exhibits a balance between semantic meaning and document structure. This balance is useful for maintaining context in complex medical narratives while facilitating efficient retrieval based on both content and layout. The hybrid chunks 542 are then tagged with metadata indicating their origin (semantic, layout, or hybrid) and relevance scores, enhancing future retrieval processes.

At Operation 5, the hybrid chunker 530 implements a data ingestion pipeline to load the hybrid set of content item chunks 542 into the chunk index 540. The chunk index 540 is specifically optimized for RAG operations in a healthcare context. The database architecture employs a distributed, sharded design to handle the volume and velocity of medical data ingestion. A chunk 542 is assigned a unique identifier and indexed using a combination of B-tree and inverted index structures for efficient retrieval. The hybrid chunker 530 implements a custom serialization protocol to preserve the hierarchical relationships and metadata of the hybrid chunks during the loading process. Data compression techniques, tailored for medical text, are applied to optimize storage efficiency without compromising retrieval speed. The chunk index 540 incorporates a multi-tiered caching mechanism to accelerate access to frequently queried chunks. ACID (Atomicity, Consistency, Isolation, Durability) compliance of the chunk index 540 is maintained to ensure data integrity in the healthcare environment. The loading process includes real-time validation checks against a medical ontology to enhance the semantic searchability of the chunks 542. Concurrent with the data loading, the hybrid chunker 530 generates and stores vector embeddings for a chunk 542, facilitating semantic similarity searches in subsequent RAG operations.

At Operation 6, the healthcare organization's RAG system 520 interfaces with the chunk index 540 to perform searches across the hybrid set of content item chunks 542. The RAG system 520 employs a multi-stage query processing pipeline. Initially, user queries undergo medical entity recognition and expansion using domain-specific ontologies. The expanded queries are then vectorized using a same embedding model applied to the chunks 542 during ingestion. The RAG system 520 executes a hybrid search strategy, combining exact match, fuzzy matching, and semantic similarity techniques. This approach leverages both the textual content and the vector representations of the chunks 542. A custom ranking algorithm, tuned for medical relevance, prioritizes search results based on a combination of semantic similarity, structural relevance, and recency. The RAG system 520 utilizes parallel processing to execute multiple search strategies simultaneously, optimizing for both speed and comprehensiveness. Query results are dynamically reranked based on user interaction patterns and relevance feedback. The RAG system 520 implements a context-aware chunk aggregation mechanism, reconstructing relevant document sections from individual chunks when necessary. This process ensures that the retrieved information maintains appropriate context and coherence. The RAG system 520's output is then used to augment the generation of clinical decision support responses, providing healthcare professionals with precise, context-rich information derived from the organization's vast repository of medical knowledge.

### 7. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. Custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

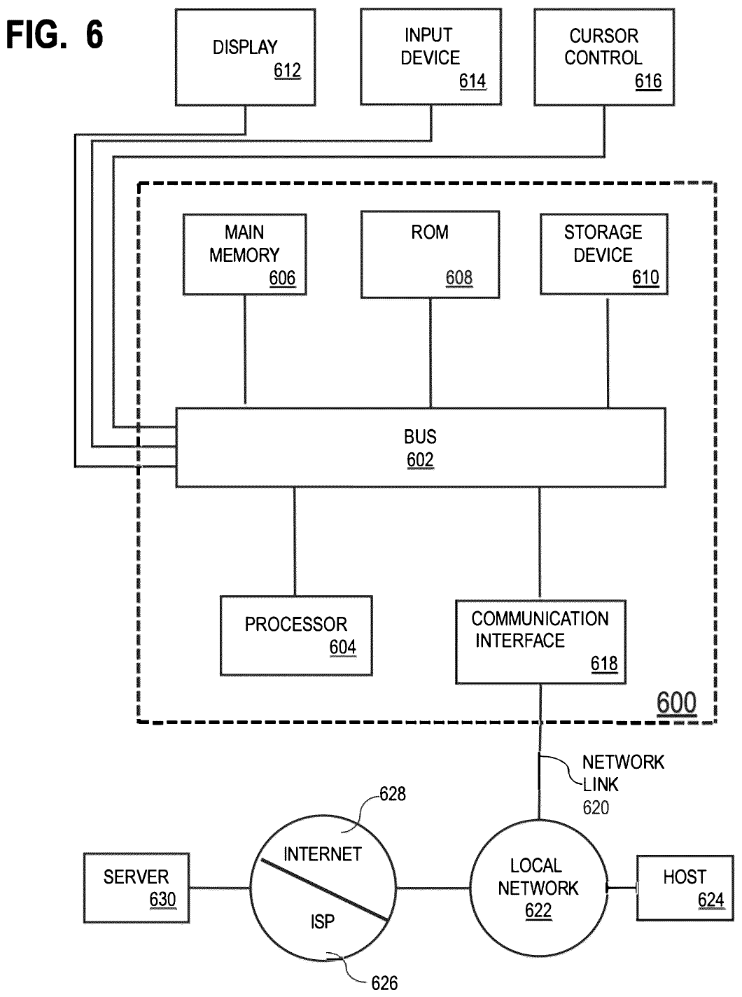

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid-State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 9. Miscellaneous; Extensions

Unless otherwise defined, all terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media comprising instructions which, when executed by one or more hardware processors, cause performance of operations comprising:
performing a combination of size-based chunking and semantic chunking on at least a portion of a content item to obtain a first set of content item chunks;
analyzing at least a portion of a content item for layout chunking indictors to determine a set of one or more layout chunking markers;
based on the set of one or more layout chunking markers, performing a combination of size-based chunking and layout chunking on at least a portion of a content item to obtain a second set of content item chunks;
combining the first set of content item chunks and the second set of content item chunks to obtain a hybrid set of content item chunks, wherein the hybrid set of content item chunks comprises one or more content item chunks of the first set of content item chunks and one or more content item chunks of the second set of content item chunks;
loading the hybrid set of content item chunks into a database system; and
invoking the database system to perform a set of one or more searches of the hybrid set of content item chunks.

2. The one or more non-transitory computer-readable media of claim 1, the operations further comprising:
parsing at least a portion of a content item into a plurality of grammatical units;
forming a set of nodes wherein each node of the set of nodes comprises a respective grammatical unit of the plurality of grammatical units and associated metadata; and
wherein the performing the combination of size-based chunking and semantic chunking is based on the set of nodes.

3. The one or more non-transitory computer-readable media of claim 1, wherein the combining the first set of content item chunks and the second set of content item chunks to obtain the hybrid set of content item chunks comprises:
identifying a content item chunk in the second set of content item chunks that overrides a corresponding content item chunk in the first set of content item chunks; and
selecting the content item chunk in the second set of content item chunks for inclusion in the hybrid set of content item chunks and omitting the corresponding content item chunk in the first set of content item chunks from inclusion in the hybrid set of content item chunks.

4. The one or more non-transitory computer-readable media of claim 1, the operations further comprising:
determining a retrieval score reflecting a number of content item chunks retrieved from the database system by a retrieval augmented generation agent that are in a set of ground truth content item chunks associated with a query submitted to the retrieval augmented generation agent; and
modifying a hybrid content item chunking process based on the retrieval score.

5. The one or more non-transitory computer-readable media of claim 1, the operations further comprising:
determining a generation score reflecting a number of intermediate responses generated by a retrieval augmented generation agent that are sufficiently semantically similar to a set of one or more content item chunks retrieved from the database system by the retrieval augmented generation agent; and
modifying a hybrid content item chunking process based on the generation score.

6. The one or more non-transitory computer-readable media of claim 1 the operations further comprising:
determining a generation score reflecting a number of a set of intermediate responses generated by a retrieval augmented generation agent that are sufficiently semantically similar to a query submitted to the retrieval augmented generation agent; wherein the set of intermediate responses are generated by the retrieval augmented generation agent based on a set of one or more content item chunks retrieved by the retrieval augmented generation agent from the database system; and
modifying a hybrid content item chunking process based on the generation score.

7. The one or more non-transitory computer-readable media of claim 1, the operations further comprising:
determining a retrieval augmented generation agent score reflecting how semantically similar an overall query response generated by a retrieval augmented generation agent is to a ground truth overall query response; wherein the overall query response is generated by the retrieval augmented generation agent based on a set of one or more content item chunks retrieved by the retrieval augmented generation agent from the database system; and
modifying a hybrid content item chunking process based on the retrieval augmented generation agent score.

8. A method comprising:
performing a combination of size-based chunking and semantic chunking on at least a portion of a content item to obtain a first set of content item chunks;
analyzing at least a portion of a content item for layout chunking indictors to determine a set of one or more layout chunking markers;
based on the set of one or more layout chunking markers, performing a combination of size-based chunking and layout chunking on at least a portion of a content item to obtain a second set of content item chunks;
combining the first set of content item chunks and the second set of content item chunks to obtain a hybrid set of content item chunks, wherein the hybrid set of content item chunks comprises one or more content item chunks of the first set of content item chunks and one or more content item chunks of the second set of content item chunks;
loading the hybrid set of content item chunks into a database system;
invoking the database system to perform a set of one or more searches of the hybrid set of content item chunks; and
wherein the method is performed by at least one device including a hardware processor.

9. The method of claim 8, further comprising:
parsing at least a portion of a content item into a plurality of grammatical units;
forming a set of nodes wherein each node of the set of nodes comprises a respective grammatical unit of the plurality of grammatical units and associated metadata; and
wherein the performing the combination of size-based chunking and semantic chunking is based on the set of nodes.

10. The method of claim 8, wherein the combining the first set of content item chunks and the second set of content item chunks to obtain the hybrid set of content item chunks comprises:
identifying a content item chunk in the second set of content item chunks that overrides a corresponding content item chunk in the first set of content item chunks; and
selecting the content item chunk in the second set of content item chunks for inclusion in the hybrid set of content item chunks and omitting the corresponding content item chunk in the first set of content item chunks from inclusion in the hybrid set of content item chunks.

11. The method of claim 8, further comprising:
determining a retrieval score reflecting a number of content item chunks retrieved from the database system by a retrieval augmented generation agent that are in a set of ground truth content item chunks associated with a query submitted to the retrieval augmented generation agent; and
modifying a hybrid content item chunking process based on the retrieval score.

12. The method of claim 8, further comprising:
determining a generation score reflecting a number of intermediate responses generated by a retrieval augmented generation agent that are sufficiently semantically similar to a set of one or more content item chunks retrieved from the database system by the retrieval augmented generation agent; and
modifying a hybrid content item chunking process based on the generation score.

13. The method of claim 8, further comprising:
determining a generation score reflecting a number of a set of intermediate responses generated by a retrieval augmented generation agent that are sufficiently semantically similar to a query submitted to the retrieval augmented generation agent; wherein the set of intermediate responses are generated by the retrieval augmented generation agent based on a set of one or more content item chunks retrieved by the retrieval augmented generation agent from the database system; and
modifying a hybrid content item chunking process based on the generation score.

14. The method of claim 8, further comprising:
determining a retrieval augmented generation agent score reflecting how semantically similar an overall query response generated by a retrieval augmented generation agent is to a ground truth overall query response; wherein the overall query response is generated by the retrieval augmented generation agent based on a set of one or more content item chunks retrieved by the retrieval augmented generation agent from the database system; and
modifying a hybrid content item chunking process based on the retrieval augmented generation agent score.

15. A system comprising:
at least one device including a hardware processor;
the system being configured to perform operations comprising:
performing a combination of size-based chunking and semantic chunking on at least a portion of a content item to obtain a first set of content item chunks;
analyzing at least a portion of a content item for layout chunking indictors to determine a set of one or more layout chunking markers;
based on the set of one or more layout chunking markers, performing a combination of size-based chunking and layout chunking on at least a portion of a content item to obtain a second set of content item chunks;
combining the first set of content item chunks and the second set of content item chunks to obtain a hybrid set of content item chunks, wherein the hybrid set of content item chunks comprises one or more content item chunks of the first set of content item chunks and one or more content item chunks of the second set of content item chunks;
loading the hybrid set of content item chunks into a database system; and
invoking the database system to perform a set of one or more searches of the hybrid set of content item chunks.

16. The system of claim 15, the operations further comprising:
parsing at least a portion of a content item into a plurality of grammatical units;
forming a set of nodes wherein each node of the set of nodes comprises a respective grammatical unit of the plurality of grammatical units and associated metadata; and
wherein the performing the combination of size-based chunking and semantic chunking is based on the set of nodes.

17. The system of claim 15, wherein the combining the first set of content item chunks and the second set of content item chunks to obtain the hybrid set of content item chunks comprises:
identifying a content item chunk in the second set of content item chunks that overrides a corresponding content item chunk in the first set of content item chunks; and
selecting the content item chunk in the second set of content item chunks for inclusion in the hybrid set of content item chunks and omitting the corresponding content item chunk in the first set of content item chunks from inclusion in the hybrid set of content item chunks.

18. The system of claim 15, the operations further comprising:
determining a retrieval score reflecting a number of content item chunks retrieved from the database system by a retrieval augmented generation agent that are in a set of ground truth content item chunks associated with a query submitted to the retrieval augmented generation agent; and
modifying a hybrid content item chunking process based on the retrieval score.

19. The system of claim 15, the operations further comprising:
determining a generation score reflecting a number of intermediate responses generated by a retrieval augmented generation agent that are sufficiently semantically similar to a set of one or more content item chunks retrieved from the database system by the retrieval augmented generation agent; and
modifying a hybrid content item chunking process based on the generation score.

20. The system of claim 15, the operations further comprising:
determining a generation score reflecting a number of a set of intermediate responses generated by a retrieval augmented generation agent that are sufficiently semantically similar to a query submitted to the retrieval augmented generation agent; wherein the set of intermediate responses are generated by the retrieval augmented generation agent based on a set of one or more content item chunks retrieved by the retrieval augmented generation agent from the database system; and
modifying a hybrid content item chunking process based on the generation score.
